(19) United States
(12) Patent Application Publication
(10) Pub. No.: US 2007/0156890 A1
(43) Pub. Date: Jul. 5, 2007

(54) Method for tracking network transactions

(75) Inventor: Thomas Promny, Hamburg (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: adfire GmbH

(21) Appl. No.: 11/385,498

(22) Filed: Mar. 21, 2006

Related U.S. Application Data
(63) Continuation of application No. PCT/EP06/00059, filed on Jan. 5, 2006.

(51) Int. Cl. G06F 15/173

(52) U.S. Cl. 709/224

(57) ABSTRACT

A method, software product, a computer readable medium and a system for tracking network transactions in a data network, the method comprising at least one client and at least three servers, wherein data is transmitted over the data network between at least one client and at least a first server and at least a second server and wherein a third server monitors and/or evaluates data network transactions.

### CROSS-REFERENCE TO RELATED APPLICATIONS

The present application is a continuation application that claims priority under 35 U.S.C. §119 of International Patent Application No. PCT/EP2006/000059, filed on Jan. 5, 2006, the disclosure of which is expressly incorporated by reference herein in its entirety.

### BACKGROUND

The invention relates to a method for tracking network transactions in a data network comprising at least one client and at least three servers, wherein data is transmitted over the data network between at least one client and at least a first server and at least a second server and wherein a third server monitors and/or evaluates data network transactions. Furthermore, the invention relates to a software product comprising program code means, a server application, a computer readable medium and also a system for tracking networks transactions in a data network.

Methods for tracking network transactions in data networks are known. For example, the success of Internet advertising campaigns is monitored using so-called ad tracking methods. An example of a data network is the worldwide Internet (World Wide Web, WWW). Methods for tracking, for example, access frequencies on certain websites, are generally used, even without any relation to advertising, for example, in order to derive data about the times of day at which such sites are called up or data as to how many accesses were made to the sites and from which geographic regions or countries. These methods are also applicable in intranets or in any data networks apart from the WWW.

Internet advertising has found widespread circulation on the Internet. Providers of goods or services try to draw potential customers “surfing” the Internet to their own websites on which they offer their products. Suitable advertising media on the Internet are Internet sites of third party providers having large public demand, for example search engines, Internet portals, online auction houses, providers of free email accounts and similar online services.

In order to place an advertisement on an Internet site of such a third party provider who has high public demand and is also called publisher or advertising medium, an advertising company (referred to in the following as “advertising client”) purchases advertising spaces on the Internet sites of the publisher in order to allow banner advertisements to be placed thereon. The advertisement can also be placed as an entry into a list with a link, thus as a referral to another Internet site.

Within the scope of an advertising campaign, an advertising client usually places his advertisement on the sites of a plurality of publishers. For evaluating the success of the advertising campaign in relation to the individual publishers, methods and systems are known using which a statistical evaluation of the behavior of Internet users is possible. For this purpose, for every process in which an Internet user who clicks in his browser on the advertisement of an advertising client on the Internet site of a publisher, the network address of the computer of the Internet user is determined in addition to the identity of the publisher and of the advertising client. If necessary, additional data such as the time point of the activation of an advertising link and other transactions are recorded. Examples of transactions are the conclusion of a purchase contract, the registration as a customer of the advertising client, the enquiry for additional information, etc.

This takes place in the prior art in that the data on the Internet site of the publisher, said data representing the advertisement of the advertising client, contains a link to a tracking server of a provider of ad tracking services, which cause the browser of the computer of the Internet user to contact the tracking server and to transmit to it data about the computer of the Internet user, about the publisher and about the advertising client. The tracking server is independent both of the server of the publisher as well as of the server of the advertising client. A known example of an ad tracking service provider which uses this technology can be found at the World Wide Web at the address falkag.de.

Since the computer of the Internet user is directly connected to the tracking server, the tracking server is in a position to collect the required data about the computer of the Internet user and to make the data accessible for evaluation. Here it is apparent to the Internet user as to who is the advertising medium. This can be detected from the address, which is displayed in the link to the tracking server. Once the data is collected, the tracking server transmits data to the computer of the Internet user, wherein said data causes the browser of the user to establish a connection to the server of the advertising client, who has paid for the advertisement on the Internet site of the publisher.

After the establishment of the connection between the computer of the Internet user and the server of the advertising client, transactions are possible using this connection between the advertising client and the Internet user. After the conclusion of transactions the server of the advertising client contacts the tracking server and transmits details about the transactions. Based on these data, result statistics are compiled in addition to pure click statistics.

### SUMMARY

Based on this prior art, it is the object of the present invention to provide a method for tracking network transactions in a data network and also a software product and a server application, using which it is possible to establish connections for network transactions and to carry out and track network transactions rapidly and securely.

This object is achieved by a method for tracking network transactions in a data network comprising at least one client and at least three servers, wherein data is transmitted using this data network between at least one client and at least a first server and at least a second server and wherein a third server monitors and/or evaluates data network transactions, said method comprising the following process steps:
a) Establishing a data network connection between a client and a first server,
b) Transmitting data about at least one data network address of at least one second server by the first server to the client,
c) Selecting a data network address of a second server from the data transmitted in step b),
d) Establishing a data network connection between the client and a second server by means of the data network address selected in step c),
e) Establishing a data network connection between the second server and the third server and
f) Transmitting data to the third server by the second server, said data being related at least partly to the client, the first server and/or the second server.

The invention is based on the basic principle that unlike in the prior art, no third server, for example a tracking server, is used as an intermediary, which initiates a data network connection between the client and the second server after a data network connection has been established between the client and the first server. Instead of that, the client is forwarded directly by the advertisement on the first server to the second server without a roundabout route using a third server or a tracking server. This method is also applicable in the performance assessment of online advertising campaigns, without being limited thereto. In fact, there are possible applications wherever the behavior of users of data networks is assessed.

The inventive method cuts down on the time required in the known method by the third server to collect the necessary data and to refer the client further to the second server. The client is connected to the second server, for example the server of an advertising client, more rapidly.

The task of collecting data of the client and of the first server, for example, the server of a publisher, now falls to the second server, which then forwards the collected data to the third server. This forwarding takes place without the participation of the client. Furthermore, the referral of the Internet user to the second server no longer depends on the reachability of the third server. A data network connection is thus established between the client and the second server, for example, after a user clicks on an advertisement on an Internet site of a publisher even if the third server is temporarily or permanently not reachable.

A side effect of this measure is that search engines, which look for referrals and/or links on the Internet sites of third party providers, for example of publishers, and compile ranking lists according to reference frequencies, come directly across the referrals to the second server and the Internet presence of the operator of the second server, thus for example, of an advertising client, is accordingly highly ranked. With a high ranking, the site of the advertising client is then mentioned far above in a list of search hits, thus making it easily noticeable for the searcher. Such a placement is not possible if the user is first referred by the first server to the third server, as is the case in the prior art.

In addition, in contrast to the prior art, the inventive method anonymizes the advertising medium, i.e. the Internet user can no longer find out who the advertising medium and/or the publisher is on the basis of the links. Thus, search engines can also no longer draw inferences on website networks belonging together on the basis of the IDs present in the tracking URLs. This is significant especially for search engine optimizers, which had to make great efforts so far in order to make it impossible for the search engines to identify networks of websites.

Data is preferably transmitted from the client to the second server using the first server in the data network connection established in step d) between the client and the second server. This enables an identification of the operator of third party sites, for example, of the publisher.

If the second server preferably transmits to the client data, especially data for data network transactions before and/or after the transmission of data to the third server in step f), it is possible to carry out additional transactions or to transmit additional information to the Internet user. In doing so, the point of time of the transmission of data from the second and the third server is flexibly selectable. The selection of the point of time of the transmission of the data from the second to the third server depends on whether and which transactions are carried out between the client and the second server.

The method meets with an advantageous development if the data transmitted in step f) additionally contains information about data network transactions between the client and the second server. An accurate and success-oriented evaluation of the transaction data and connection data is then possible by means of the transaction data. The data are used inter alia in order to determine whether users who, using advertisements at certain publishers, arrive at the Internet presence of an advertising client, make especially many transactions, for example purchases with the advertising client. In an advertising campaign, advertisements and/or advertising spaces are then increasingly placed with publishers in whose case the advertisement of the advertising client has generated a lot of sales.

If the data transmitted in step f) is advantageously buffered in the second server before the transmission, the point of time of the transmission of the data to the third server is freely selectable. The point of time is made especially dependent on the temporarily variable transmission capacity of the data network or on the load of the second server or of the third server. The third server is contacted several times by the second server if several consecutive transactions are carried out between the client and the second server.

In order to ensure a secure tracking of data network transactions, it is advantageous if the data is transmitted by the second server to the third server in step f) only if the third server is reachable. For this purpose the second server makes contact with the third server and transmits its data only if the contact was successfully made. The data to be transmitted thus does not get lost.

So as to not overload the data network and in order to further permit transactions, for example, between the client and the second server, in a preferred embodiment of the method, the data is transmitted by the second server to the third server in step f) only if the data transmission capacity of the data network and/or of the second server and/or of the third server exceeds a predeterminable value. Thus priority is granted to transactions as opposed to the transmission of data about the transactions to the third server and it is ensured that the transactions are also carried out in the case of temporarily low transmission capacity of the network and/or high load of the servers.

In order to allow a comprehensive evaluation of the transaction data, preferably only data comprising information about the client and/or the first server and/or the second server is transmitted in step f) from the second server to the third server.

Furthermore, the data transmitted in step f) is preferably stored and/or evaluated in the third server. The third server, which forms the collecting station for all transaction data is thus advantageously in a position to carry out statistical evaluations of the transaction data stored therein. This is the function, for example, of a tracking server, however, to the exclusion of the known additional function of recognizing a client computer and forwarding the client to a second server of an advertising client.

The object underlying the invention is further achieved by a software product having program code means in order to carry out on the second server all the steps related to a second server in accordance with the method described above. The software product is preferably storable on at least one data carrier or medium and the software product is preferably executable on a second server.

The object underlying the invention is further achieved by the server application for carrying out the process steps of the method described above, said process steps being related to a first server, to a second server or to a third server.

The operating mode of each of these servers is modified compared to servers, which carry out the method known from the prior art. Unlike the case in the prior art, the first server thus no longer transmits the data network addresses or similar characteristics of a third server, but instead those of the second server back to the client. The second server is embodied unlike the case in the prior art in such a way that the second server now comprises means for detecting the data network addresses and/or other relevant data of the client and/or of the first server, which refers to the second server and further transmits this data automatically to the third server. In contrast, the third server is embodied in such a way that it no longer detects the information about the client and the first server using its own connection to the client but instead reads out this information from the data transmitted to it by the second server. Alternatively, the third server is preferably applicable both for carrying out the inventive method as well as for carrying out a known method, if only some of the advertising clients use the inventive method.

Any programing language, which is suitable for the communication on the Internet or another data network, for example, in an intranet, and using which the data network addresses or another characteristic of the client or of a server can be transmitted, serves for implementing the inventive method in the case of the client and in the case of the first, second and third servers. Examples thereof include Java, XML, HTML, PHP, Curl, etc. PHP offers the possibility of retrieving the data network address of the site using which the user arrives at the current Internet site, by means of the variable HTTP_REFERER in addition to the data network address of the client in the variable REMOTE_ADDR, and also the data network address of the called-up Internet site of the advertising client by means of the variable RFQUEST_URI.

The object underlying the invention is further achieved by a computer readable medium having a computer program stored thereon for performing the computer executed steps of:

a) establishing a data network connection between a client and a first server,
b) transmitting data having at least one data network address of at least one second server by the first server to the client,
c) selecting a data network address of a second server from the data transmitted in step b),
d) establishing a data network connection between the client and a second server by use of the data network address selected in step c),
e) establishing a data network connection between the second server and the third server and
f) transmitting data, which is related at least partly to at least one of the client, the first server and the second server by the second server to the third server.

The object underlying the invention is farther achieved by a system for tracking network transactions in a data network, the data network having at least one client and at least three servers, wherein data is transmitted over the data network between at least one client and at least a first of the servers and at least a second of the servers and wherein a third of the servers monitors data network transactions, said system comprising at least one of the at least three servers, the system being operative to perform the following:
a) establishing a data network connection between a client and a first server,
b) transmitting data having at least one data network address of at least one second server by the first server to the client,
c) selecting a data network address of a second server from the data transmitted in step b),
d) establishing a data network connection between the client and a second server by use of the data network address selected in step c),
e) establishing a data network connection between the second server and the third server and
f) transmitting data, which is related at least partly to at least one of the client, the first server and the second server by the second server to the third server.

### BRIEF DESCRIPTION OF THE DRAWINGS

The invention is described in the following on the basis of embodiments, without restricting the general inventive thought to said embodiments, and with reference to the drawings, which should be expressly referred to for all inventive details that are not explained more elaborately in the text.

FIG. 1 is a schematic illustration of an arrangement of a client and three servers and of data network connections according to a method from the prior art,

FIG. 2 is a flowchart of a known method,

FIG. 3 is a schematic illustration of an arrangement and of data network connections for carrying out an embodiment of an inventive method, and

FIG. 4 is a flowchart of another embodiment of an inventive method.

Like or similar elements and/or corresponding parts are provided with the same reference numerals in the following figures with a view to omit a corresponding repetition thereof.

### DETAILED DESCRIPTION

The particulars shown herein are by way of example and for purposes of illustrative discussion of the embodiment of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the present invention may be embodied in practice.

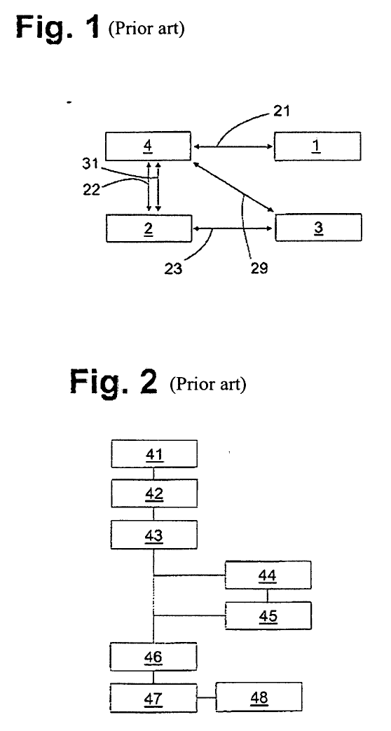

FIG. 1 illustrates an arrangement, which is known from the prior art, of a client 4 and also of a known first server 1, second server 2 and third server 3. The third server 3 is, for example, a known tracking server. The double arrows symbolize data network connections 21, 22, 23, 29, which are established between the different computers in the course of the implementation of the known method. The implemented steps are illustrated schematically in FIG. 2. The following description of a known method for tracking data network transactions therefore refers to FIG. 1 and FIG. 2.

In FIG. 1 the client 4 represents a computer, which is connected to the Internet. As the software, the client 4 comprises an Internet browser, for example, the Microsoft Internet Explorer, Opera or Firefox, which enables the display of Internet sites of other servers as well as the implementation of transactions over the Internet, for example, using HTML, PHP or Java.

An advertising client operates a second server 2, which is designed for carrying out transactions with the client 4, for example, the sale of goods or ordering or providing services. The advertising client places advertising messages on one or more first servers 1 of advertising media and/or publishers. The advertising message contains a link to the network address of a third server 3 of an ad tracking service provider and also a referral to the advertising client, however no link to the second server 2 of the advertising client. The content is usually in an encrypted form, which can be decoded only by the third server 3.

In the first process step of the known method marked with the reference symbol 41 in FIG. 2, the user opens a data connection 21 illustrated in FIG. 1 from the client 4 to the first server 1. The data connection is based, for example, on the Hypertext Transfer Protocol (HTTP).

Using the data network connection 21, the first server 1 transmits to the client 4 in step 42 in FIG. 2 contents, for example, websites, which contain especially banner advertisements or links of advertising clients and are displayed by the browser on the client 4. For example, search engines or Internet portals return to the client advertising messages or referrals related to the search topics or regions.

In step 43 of FIG. 2, the user selects the offer of the advertising client by clicking on the advertisement of the operator of the second server 2 in the site of the first server 1. The browser in the client 4 is thus forwarded to the third server 3. The client 4 establishes in step 44 a data network connection 29 to the third server 3 and transmits thereto inter alia the data network address of the client 4 and also the data network address or other characteristics of the first server 1 and also of the second server 2.

After the third server 3 has stored this data, it transmits new data to the client 4 in step 45 over the data network connection 29, for example, a link to the second server 2 of the advertising client, wherein said data causes the client 4 to establish in step 46 a data connection 22 to the second server 2 of the provider of the advertised goods or services.

Subsequently, in step 47 transactions 31 are made between the client 4 and the second server 2 over the data network connection 22, for example, the purchase of goods, ordering of services, login of a user, exchanging addresses, etc. If transactions 31 take place, the second server 2, if necessary, establishes in step 48 another data connection 23 to the third server 3, the tracking server, in order to transmit thereto additional data about the transactions 31, which are used in the third server 3 for improving the evaluation of the advertising campaign of the operator of the second server 2. For example, the referrals of users with clients 4 whose data network addresses are known to the third server 3 are weighted as to whether transactions 31 with the second server 2 have taken place and which transactions 31 have taken place or about the sales volume generated.

In the flowchart according to FIG. 2 the process steps 44 and 45, which are related to the connection 29 between the client 4 and the third server 3, are displaced towards the right. A dashed line connects the process steps 43 and 46. It is thus revealed that the third server 3 appears only briefly and occurs visibly for the user only as an intermediary between the first server 1 and the second server 2.

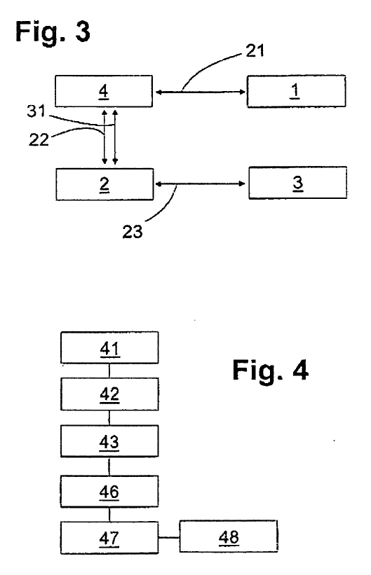

FIG. 3 and FIG. 4 schematically illustrate an arrangement and data network connections for the implementation of an inventive method and also a flowchart of an inventive method for tracking network transactions.

Unlike the known method illustrated in FIG. 1 and FIG. 2 the data network connections 29 between the client 4 and the third server 3, the tracking server, are omitted and also the process steps 44 and 45, which are related to the data network connection 29 between the client 4 and the third server 3.

In step 41 of FIG. 4, a data network connection 21 is established in turn between the client 4 and the first server 1 on the request of the user in the web browser of the client 4 illustrated in FIG. 3, whereupon in the following step 42 the first server 1 transmits data to the client 4, which contains, for example, the advertising message of an operator of a second server 2. In this case, however, this data does not contain the data network address of a third server 3, instead directly the data network address or a similar identifier of one or more second servers 2.

Upon the transmission of the data from the first server 1, the user in step 43 selects an advertising message, whereupon in step 46 the client contacts the corresponding second server 2 by circumventing the third server 3. The client 4 transmits data to the second server 2 which contains inter alia an identifier of the website called up on the first server 1 or the data network address of the first server 1.

In the following step 47 transactions 31 are made (47) in the usual manner between the client 4 and the second server 2. Before, during or after the conclusion of the transactions 31, the second server 2 opens in a step 48 a data network connection 23 to the third server 3, the tracking server, and transmits thereto data relating to the first server 1, the second server 2, the client 4 and the transactions 31, which are made between the client 4 and the second server 2.

The following example of a programming code in the language PHP including the extension of Curl describes how individual aspects of the inventive method can be implemented in software on the second server 2 of the advertising client by means of “HTTP-POST.” In the following, indented program lines stand for the continuation of the previous programming line.

$referer=$_SERVER[‘HTTP_REFERER’];
if(strstr($referer, $_SERVER[‘HTTP_HOST’])) {exit;}
If(!isset($_SERVER[‘HTTP_REFERER’]) OR

!strstr($_SERVER[‘HTTP_REFERER’], “http“)) {exit;}

$userip=$_SERVER[‘REMOTE_ADDR’];
$time=time( );
$url=$_SERVER[‘HTTP_HOST’]. $_SERVER[‘REQUEST_URI’];
$data=””;
$password=”xyz”;

Here the environment variable “HTTP_REFERER” is initially defined automatically by PHP by means of “$_SERVER.” It contains the URL (Uniform Resource Locator) or network address of the Internet site using which a visitor arrives on the current Internet site of the advertising client.

The command in the second line of the programming text deals with the case that the referring site is simultaneously the domain of the advertising client, thus the visitor is not referred to the current site from the outside. In this case the action is discontinued. The negation “!” of the command “isset” in the third programming line means that the variable is not present or has no value. In this case or if no “http” is contained in the referring address, the action is discontinued since there is no valid information about the origin of the visitor, e.g. because the browser or Firewall of the visitor prevent it. This happens in a small number of the cases.

Subsequently, the network address of the client 4 of the user is read out in the variable “$userip” so that the visitor can be identified and a tracking of transactions can be carried out. Furthermore, the exact point of time of the process is saved in the variable “$time.” The data network address (URL) of the called-up site on the server of the advertising client is saved in “$url,” and also any quantity of data is saved in the variable “$data,” which are later transferred to a tracking server, for example, about actions or transactions of the visitor, such as a registration or a purchase. The same applies for a password, which is yet to be determined, in the variable “$password.”

The thus determined data about the visitor and/or his client-computer 4, the first server 1 of the advertising medium and the current web page of the advertising client on the second server 2 are transferred to a tracking server, for example, as follows:

$ch = curl_init(http://TrackingServer.com/getData.php);
curl_setopt($ch, CURLOPT_MUTE, 1);
curl_setopt($ch, CURLOPT_TIMEOUT, 5);
curl_setopt($ch, CURLOPT_RETURNTRANSFER, 1);
curl_setopt($ch, CURLOPT_USERAGENT, “InvisibleTracking.com

data transfer bot”);

curl_setopt($ch, CURLOPT_POSTFIELDS, “referer=$referer&user-

ip=$userip&time=$time&url=$url&data=$data&password=$pass
word”);

$text = curl_exec($ch);
curl_close($ch);

In these programming lines a data transfer “$ch” to a tracking server identified with its data network address is initialized and transfer options related to waiting time, reception of a reply from the tracking server, the data transfer program (“Agent”) to be used and the data to be transmitted are set. The data transfer is started using the second to last command. Messages accumulating during the transfer are saved in the variable “$text.” The data transfer is completed using the last command.

The program “getData.php” mentioned in the first line of the second programming block is saved on the third server 3, the tracking server and is implemented there. It contains, for example, the following instructions:

If($_POST[‘password’]!=“xyz”) {exit;}
$query=“INSERT INTO tracking (‘referer’, ‘userip’, ‘time’, ‘url’,

‘data’) VALUES (‘$_POST[referrer]’, ‘$_POST[userip]’,
‘$_POST[time]’, ‘$_POST[url]’, ‘$_POST[data]’)”;

$result=mysql_query($query);

Here the first inquiry is whether the password transferred to the tracking server is valid and the process is discontinued in the case of an invalid password. Next, in the variable “$query” a command for an action in an SQL database is stored, which is carried out in the subsequent step by means of “mysql_query.” The command “INSERT INTO tracking” causes the values “VALUES ($_POST[ ])” mentioned in the argument of the command to be inserted as the new dataset into the corresponding variables of the database “tracking.” Here these newly inserted data are available from now on for evaluation.

On the tracking server, for example, conversion statistics are compiled which provide information about how high the ratio of the purchasers to the visitors is, how many new users have logged in per day and what sales volume is generated by the respective advertising medium (publisher). For this purpose a correlation between the referrer URL and the advertising medium account is created and if necessary, remuneration for the actions taken place is credited to the advertising medium if a certain advertising medium is identified.

On the other hand user actions, which arrive from third-party Internet sites and not from registered advertising media onto the sites of the advertising client, are sorted out and deleted by the tracking server, if necessary.

Using the inventive method, the roundabout way over a tracking server 3 is cut down so that the forwarding from the first server 1 to the second server 2, i.e. for example, the time span between clicking on a banner advertisement and the forwarding to the second server on which the advertised products or services are provided are substantially reduced. Furthermore, this saves network capacity and leads to a secure forwarding to the second server 2 since the user is forwarded even if the third server 3, e.g. a tracking server is not available or is not reachable.

It is noted that the foregoing examples have been provided merely for the purpose of explanation and are in no way to be construed as limiting of the present invention. While the present invention has been described with reference to an exemplary embodiment, it is understood that the words which have been used are words of description and illustration, rather than words of limitation. Changes may be made, within the purview of the appended claims, as presently stated and as amended, without departing from the scope and spirit of the invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of reference symbols

1 First server
2 Second server
3 Third server
4 Client
21-23 Data network connection
29 Data network connection
31 Data network transaction
41 Establishment of a client—first server connection
42 First server transmits data to client
43 Second server is selected
44 Establishment of a client—third server connection
45 Third server transmits data to client
46 Establishment of a client—second server connection
47 Transactions between client and second server
48 Second server transmits data to third server

1. A method for tracking network transactions in a data network comprising at least one client and at least three servers, wherein data is transmitted over the data network between at least one client and at least a first of the servers and at least a second of the servers and wherein a third of the servers monitors data network transactions, said method comprising the following steps:
a) establishing a data network connection between a client and a first server,
b) transmitting data having at least one data network address of at least one second server by the first server to the client,
c) selecting a data network address of a second server from the data transmitted in step b),
d) establishing a data network connection between the client and a second server by use of the data network address selected in step c),
e) establishing a data network connection between the second server and the third server and
f) transmitting data, which is related at least partly to at least one of the client, the first server and the second server by the second server to the third server.

2. The method according to claim 1, wherein, in the data network connection established in step d) between the client and the second server, data about the first server is transmitted from the client to the second server.

3. The method according to claim 1, wherein the second server transmits data for data network transactions to the client.

4. The method according to claim 1, wherein the data transmitted in step f) contains additional information about data network transactions between the client and the second server.

5. The method according to claim 1, wherein the data transmitted in step f) is buffered in the second server before transmitting.

6. The method according to claim 1, wherein the data is transmitted by the second server to the third server in step f) only if the third server is accessible.

7. The method according to claim 1, wherein the data is transmitted by the second server to the third server in step f) only if at least one of data transmission capacity of the data network, data transmission capacity of the second server and data transmission capacity of the third server exceeds a predeterminable value.

8. The method according to claim 1, wherein only such data are transmitted in step f) from the second server to the third server, which comprises information about at least one of the client, the first server, and the second server.

9. The method according to claim 1, wherein the data transmitted in step f) is at least one of stored and evaluated in the third server.

10. Software product having program code means in order to carry out on the second server the steps of the method according to claim 1 related to a second server.

11. Software product according to claim 10, which is storable on at least one data carrier or medium.

12. Software product according to claim 10, which is executable on a second server. or medium.

13. Server application for carrying out the process steps of the method according to claim 1, said process steps being related to a first server.

14. Server application for carrying out the process steps of the method according to claim 1, said process steps being related to a second server.

15. Server application for carrying out the process steps of the method according to claim 1, said process steps being related to a third server.

16. A computer readable medium having a computer program stored thereon for performing the computer executed steps of:
a) establishing a data network connection between a client and a first server,
b) transmitting data having at least one data network address of at least one second server by the first server to the client,
c) selecting a data network address of a second server from the data transmitted in step b),
d) establishing a data network connection between the client and a second server by use of the data network address selected in step c),
e) establishing a data network connection between the second server and the third server and
f) transmitting data, which is related at least partly to at least one of the client, the first server and the second server by the second server to the third server.

17. A system for tracking network transactions in a data network, the data network having at least one client and at least three servers, wherein data is transmitted over the data network between at least one client and at least a first of the servers and at least a second of the servers and wherein a third of the servers monitors data network transactions, said system comprising at least one of the at least three servers, the system being operative to perform the following:
a) establishing a data network connection between a client and a first server,
b) transmitting data having at least one data network address of at least one second server by the first server to the client,
c) selecting a data network address of a second server from the data transmitted in step b),
d) establishing a data network connection between the client and a second server by use of the data network address selected in step c),
e) establishing a data network connection between the second server and the third server and
f) transmitting data, which is related at least partly to at least one of the client, the first server and the second server by the second server to the third server.
